(19) United States
(12) Patent Application Publication
(10) Pub. No.: US 2014/0344006 A1
(43) Pub. Date: Nov. 20, 2014

(54) ANALYTICS BASED SERVICE CATALOG MANAGEMENT

(71) Applicant: International Business Machines Corporation, Armonk, NY (US)

(72) Inventors: Ana C. Biazetti, Cary, NC (US); Leucir M. Junior, Sao Paulo (BR)

(73) Assignee: International Business Machines Corporation, Armonk, NY (US)

(21) Appl. No.: 13/894,808

(22) Filed: May 15, 2013

(51) Int. Cl. G06Q 10/06; G06Q 30/00

(52) U.S. Cl. CPC G06Q 10/0633; G06Q 30/016
USPC 705/7.27

(57) ABSTRACT

Embodiments of the present invention disclose a method, computer program product, and system for service catalog management. A computer identifies information corresponding to a plurality of service requests included on a service desk, wherein the identified information includes usage and financial information corresponding to the plurality of service requests. The computer determines a service offering candidate for inclusion in a service catalog, wherein the service offering candidate is determined from the plurality of service requests included in the service desk. The computer determines a fulfillment solution corresponding to the service offering candidate, wherein the fulfillment solution includes a workflow process for the service offering candidate, scripts for automating procedures, offering parameters, and costs associated with the service offering candidate. In another embodiment, the computer activates the service offering candidate and corresponding fulfillment solution in the service catalog after receiving approval.

### FIELD OF THE INVENTION

The present invention relates generally to the field of Information Technology Service Management (ITSM), and more particularly to service catalog management.

### BACKGROUND OF THE INVENTION

Information Technology Service Management (ITSM) is a discipline for managing Information Technology (IT) systems and services, with a focus on contributions of IT services to an organization. In ITSM, processes such as service request management, change management, release management and deployment management can be utilized to manage an IT environment. Service request management includes management of an organizations service desk, service portfolio and service catalog. A service desk is a program or system that allows users to report problems (tickets) or make requests for help. The Information Technology Infrastructure Library (ITIL) defines the service portfolio as a complete listing of all proposed, live, and retired services associated with the organization. The service catalog is a subset of the service portfolio, consisting of active services available to customers or members of an organization.

A service catalog can include self-service offerings that individuals can utilize to resolve an issue without direct interaction with individuals that can provide support to the issue. Individuals utilizing self-service offerings in a service catalog can provide reductions in operating costs to an organization when compared to the cost of having individuals provide support to resolve an issue.

### SUMMARY

Embodiments of the present invention disclose a method, computer program product, and system for service catalog management. A computer identifies information corresponding to a plurality of service requests included on a service desk, wherein the identified information includes usage and financial information corresponding to the plurality of service requests. The computer determines a service offering candidate for inclusion in a service catalog, wherein the service offering candidate is determined from the plurality of service requests included in service desk. The computer determines a fulfillment solution corresponding to the service offering candidate, wherein the fulfillment solution includes a workflow process for the service offering candidate, scripts for automating procedures, offering parameters, and costs associated with the service offering candidate. In another embodiment, the computer receives approval to activate the service offering candidate and corresponding fulfillment solution in the service catalog. The computer activates the service offering candidate and corresponding fulfillment solution in the service catalog. In another embodiment, the computer determines a service offering that can be removed from the service catalog.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart depicting operational steps of a program for creating a self-service offering in a service catalog, in accordance with an embodiment of the present invention.

FIG. 3 is a flowchart depicting operational steps of a program for removing a self-service offering from a service catalog, in accordance with an embodiment of the present invention.

FIG. 4 is a flowchart depicting an exemplary processing flow of information through a data processing environment, in accordance with an embodiment of the present invention.

FIG. 5 depicts a block diagram of components of the computing system of FIG. 1 in accordance with an embodiment of the present invention.

### DETAILED DESCRIPTION

Embodiments of the present invention recognize that an important aspect of Information Technology Service Management (ITSM) is building and maintaining a service catalog that includes self-service offerings. The process from identifying candidates for self-service offerings to implementing the self-service offering into the service catalog can be a lengthy process. A static self-service catalog reduces the effectiveness of the service catalog, and can lead to decreased self-service usage. Embodiments of the present invention recognize that an ability to adapt a self-service catalog responsive to the demand of individuals utilizing the service desk (tickets created for service requests) and the self-service catalog (i.e. creating and removing offerings) can provide many benefits to an organization.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

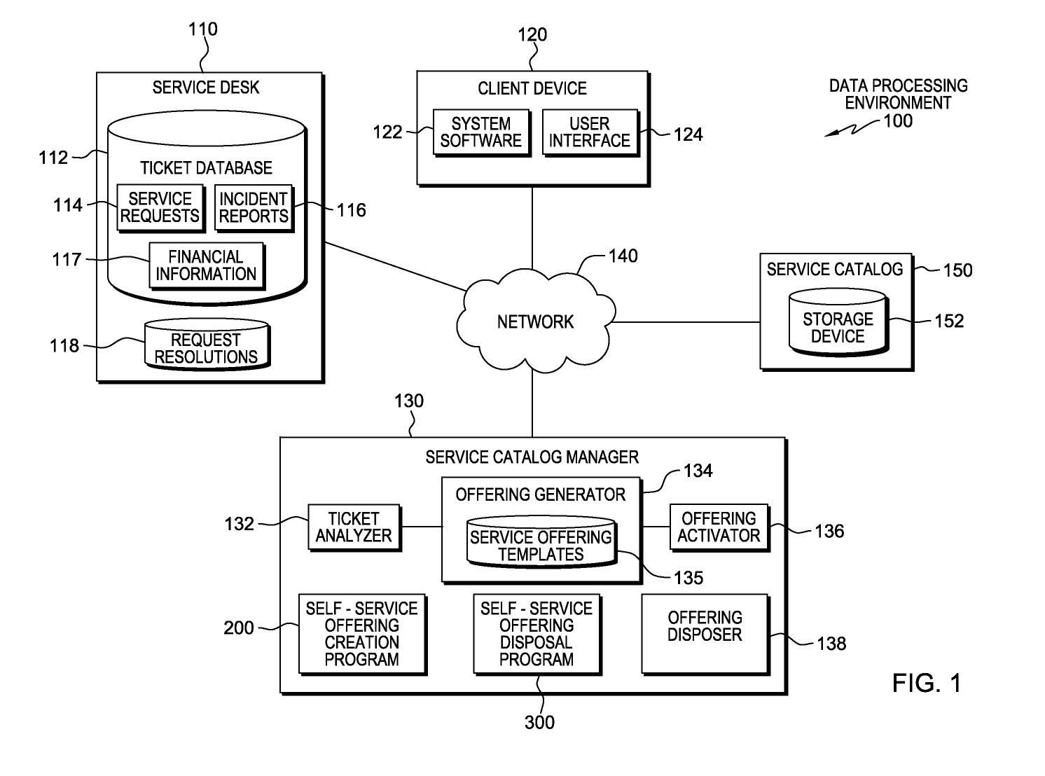

The present invention will now be described in detail with reference to the Figures. FIG. 1 is a functional block diagram illustrating data processing environment 100, in accordance with one embodiment of the present invention.

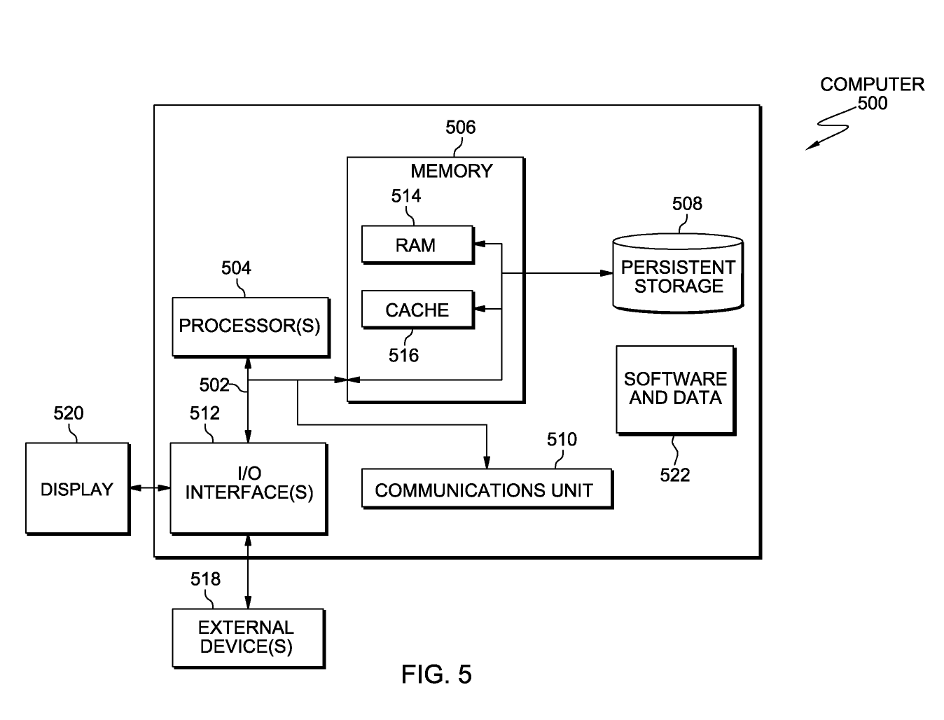

An exemplary embodiment of data processing environment 100 includes service desk 110, client device 120, service catalog manager 130, and service catalog 150 all connected via network 140. Service desk 110 is an IT service utilized in ITSM that provides a point of contact between service providers and individuals utilizing a service for reporting issues. In exemplary embodiments, individuals in an organization utilize service desk 110 to receive support with handing issues related with services that the organization provides. In one embodiment, service desk 110 creates tickets corresponding to issues that individuals contact service desk 110 to resolve. Exemplary implementations of service desk 110 can include call centers, contact centers, and help desks. In one embodiment, service desk 110 can be desktop computers, specialized computer servers, or any other computer systems known in the art. In certain embodiments, service desk 110 represents a computer system utilizing clustered computers and components (e.g., database server computers, application server computers, etc.) that act as a single pool of seamless resources when accessed by elements of data processing environment 100. In general, service desk 110 is representative of any electronic device or combination of electronic devices capable of executing machine-readable program instructions, as described in greater detail with regard to FIG. 5.

In one embodiment, service desk 110 includes ticket database 112 and request resolutions 118. Ticket database 112 and request resolutions 118 can be implemented with any type of storage device that is capable of storing data that may be accessed and utilized by service desk 110 and service catalog manager 130, such as a database server, a hard disk drive, or flash memory. In other embodiments, ticket database 112 and request resolutions 118 can represent multiple storage devices within service desk 110. In exemplary embodiments, ticket database 112 includes information corresponding to service tickets created on service desk 110. Ticket database 112 includes service requests 114, incident reports 116, and financial information 117. In exemplary embodiments, service requests 114 and incident reports 116 are representations of tickets created on service desk 110 through individuals requesting assistance and individuals reporting an incident or problem. Financial information 117 is a representation of financial information associated with tickets (i.e. service requests 114 and incident reports 116) in ticket database 112. In an example, financial information 117 includes a cost associated with the resolution to service request 114. In exemplary embodiments, request resolutions 118 includes a knowledge base for methods to resolve service requests 114 and incident reports 116.

In exemplary embodiments, an individual utilizing client device 120 can contact service desk 110 through network 140 and create service requests 114 and incident reports 116. In exemplary embodiments, an individual utilizing client device 120 can access service catalog 150 through network 140. In various embodiments of the present invention, client device 120 may be workstations, personal computers, personal digital assistants, mobile phones, or any other devices capable of executing program instructions. In general, client device 120 is representative of any electronic device or combination of electronic devices capable of executing machine-readable program instructions, as described in greater detail with regard to FIG. 5. In alternate embodiments, data processing environment 100 can include other instances of client device 120 (i.e. can have more). Client device 120 includes system software 122 and user interface 124. In one embodiment, system software 122 may exist in the form of operating system software, which may be Windows®, LINUX®, and other application software such as internet applications and web browsers. User interface 124 allows for input into client device 120. In exemplary embodiments, user interface 124 allows an individual utilizing client device 120 to communicate with service desk 110 and service catalog 150 through network 140.

In exemplary embodiments, service catalog manager 130 communicates with service desk 110 and service catalog 150 through network 140, and utilizes information stored in service desk 110 to determine candidate offerings to be included in service catalog 150, and manage self-service offerings included in storage device 152 of service catalog 150. In one embodiment, service catalog manager 130 can be a desktop computer, specialized computer server, or any other computer system known in the art. In certain embodiments, service catalog manager 130 represents a computer system utilizing clustered computers and components (e.g., database server computers, application server computers, etc.) that act as a single pool of seamless resources when accessed by elements of data processing environment 100. In general, service catalog manager 130 is representative of any electronic device or combination of electronic devices capable of executing machine-readable program instructions, as described in greater detail with regard to FIG. 5. In exemplary embodiments, service catalog manager 130 includes ticket analyzer 132, offering generator 134, offering activator 136, offering disposer 138, self-service offering creation program 200, and self-service offering disposal program 300.

In one embodiment, ticket analyzer 132 analyzes information in ticket database 112 to find utilization peaks and patterns that relate to service requests 114 and incident reports 116, and financial information 117 corresponding to the cost of service requests 114 and incident reports 116. In exemplary embodiments, service catalog manager 130 collects and analyses information in ticket database 112 to determine candidates for addition as a self-service offering (in storage device 152) in service catalog 150 corresponding to types of service requests of service desk 110. Offering generator 125 includes service offering templates 135. Service offering templates 135 includes template workflows for the process of fulfilling given types of service offerings of service desk 110 and service catalog 150 (i.e. obtaining manager approvals, invoking and running operations or scripts). Service offering templates 135 can be implemented with any type of storage device that is capable of storing data that may be accessed and utilized by offering generator 134, such as a database server, a hard disk drive, or flash memory. In other embodiments, service offering templates 135 can represent multiple storage devices within offering generator 134.

In one embodiment, offering generator 134 receives information from ticket analyzer 132 including candidates for self-service offerings in service catalog 150. Offering generator 134 utilizes request resolutions 118 and service offering templates 135 to determine appropriate definitions and fulfillment solution for a self-service offering candidate. In exemplary embodiments, offering activator receives information from offering generator 134, including definitions and fulfillment solutions corresponding to self-service offering candidates. In another embodiment, offering activator allow for modifications and/or approval to self-service offering candidates and corresponding fulfillment solutions. In another embodiment, an individual responsible for offerings on service desk 110 or service catalog 150 (i.e. a service catalog manager) utilizes offering activator 136 to make modifications to a self-service offering candidate, or approve a self-service offering candidate to add to storage device 152. In an exemplary embodiment, responsive to approval of a self-service offering, offering activator 136 can add and activate the self-service offering to storage device 152.

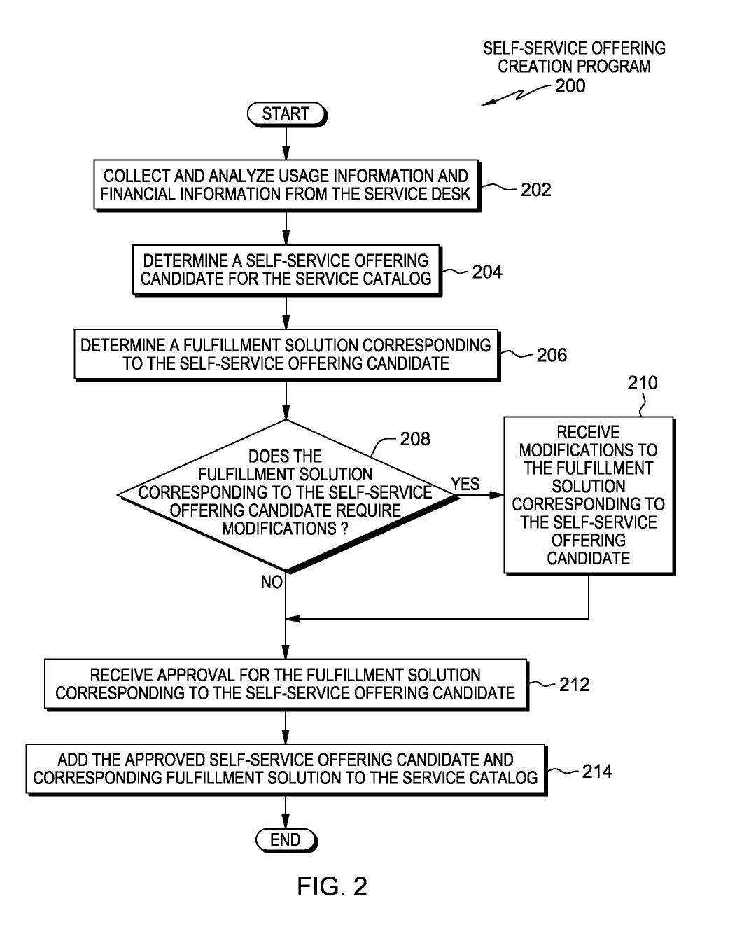

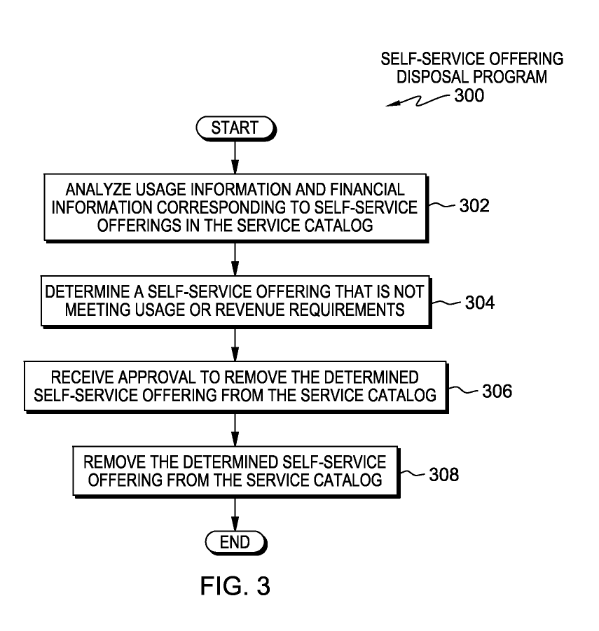

In one embodiment, offering disposer 138 can access service desk 110 and service catalog 150 through network 140 to determine self-service offerings in service catalog 150 that can be considered for decommission. In exemplary embodiments, offering disposer 138 utilizes financial information 117, as well as utilization information corresponding to self-service offerings in service catalog 150. In another embodiment, an individual responsible for offerings on service desk 110 or service catalog 150 (i.e. a service catalog manager) utilizes offering disposer 138 to approve self-service offerings for decommission and removal from service catalog 150. In exemplary embodiments, self-service offering creation program 200 and self-service offering disposal program 300 access information on service desk 110 and service catalog 150 through network 140. Self-service offering creation program 200 utilizes ticket analyzer 132, offering generator 134 and offering activator, along with information from service desk 110 and service catalog 150 to create self-service offerings for inclusion in storage device 152. Self-service offering creation program 200 is discussed in greater detail with regard to FIG. 2. In exemplary embodiments, self-service offering disposal program 300 utilizes offering disposer 138 along with information from service desk 110 and service catalog 150 to remove self-service offerings from storage device 152. Self-service offering disposal program 300 is discussed in greater detail with regard to FIG. 3.

In one embodiment, elements of data processing environment 100 communicate through network 140. Network 140 can be, for example, a local area network (LAN), a telecommunications network, a wide area network (WAN) such as the Internet, or a combination of the three, and include wired, wireless, or fiber optic connections. In general, network 140 can be any combination of connections and protocols that will support communications between service desk 110, client device 120, service catalog manager 130, and service catalog 150 in accordance with exemplary embodiments of the present invention.

In one embodiment, service catalog 150 includes storage device 152, which includes self-service offerings that provide automated resolution corresponding to issues earlier resolved in a non automated way through service desk 110. In one embodiment, service catalog 150 can be desktop computers, specialized computer servers, or any other computer systems known in the art. In certain embodiments, service catalog 150 represents a computer system utilizing clustered computers and components (e.g., database server computers, application server computers, etc.) that act as a single pool of seamless resources when accessed by elements of data processing environment 100. In general, service catalog 150 is representative of any electronic device or combination of electronic devices capable of executing machine-readable program instructions, as described in greater detail with regard to FIG. 5. In another embodiment, storage device 152 includes usage and financial information for self-service offerings included in service catalog 150. Storage device 152 can be implemented with any type of storage device that is capable of storing data that may be accessed and utilized by service catalog 150, such as a database server, a hard disk drive, or flash memory. In other embodiments, storage device 152 can represent multiple storage devices within service catalog 150. In one embodiment, service catalog manager 130 manages self-service offerings included in storage device 152. In another embodiment, an individual utilizing client device 120 can access self-service offerings (in storage device 152) on service catalog 150 through network 140.

FIG. 2 is a flowchart depicting operational steps of self-service offering creation program 200 in accordance with an exemplary embodiment of the present invention. In one embodiment, self-service offering creation program 200 runs on service catalog manager 130 while service desk 110 is operating. In exemplary embodiments, self-service offering creation program 200 utilizes ticket analyzer 132, offering generator 134, and offering activator 136 in service offering catalog 130.

In step 202, self-service offering creation program 200 collects and analyzes usage information and financial information from the service desk. In one embodiment, self-service offering creation program 200 utilizes ticket analyzer 132 to access information stored in ticket database 112 corresponding to usage of service desk 110, and financial information 117 associated with tickets on service desk 110. The usage information includes, but is not limited to, the number of service requests 114 and incident reports 116 in ticket database 112 corresponding to certain issues, and creation times of service requests 114 and incident reports 116. In an example, self-service offering creation program 200 can collect an analyze service requests 112 and incident reports 114 corresponding to authentication failures on client device 120. In this example, self-service offering creation program 200 also collects and analyzes financial information 117 corresponding to costs of resolving service requests 112 and incident reports 114 corresponding to authentication failures on client device 120. In exemplary embodiments, self-service offering creation program 200 analyzes the usage information and financial information 117 looking for repetitive behaviors (i.e. patterns of service requests 114 and incident reports 116) and utilization peaks in service desk 110 corresponding to a certain offering that service desk 110 provides. Self-service offering creation program 200 utilizes ticket analyzer 132, which continuously analyzes ticket database 112.

In step 204, self-service offering creation program 200 determines a self-service offering candidate for the service catalog. In one embodiment, self-service offering creation program 200 utilizes ticket analyzer 132 to determine a self-service offering candidate for inclusion in storage device 152 on service catalog 150. In exemplary embodiments, utilizing information from step 202, self-service offering creation program 200 can determine one or more self-service offering candidates. In one embodiment, self-service offering creation program 200 determines a service offering candidate for inclusion in service catalog 150 that corresponds to a volume of service requests 114 and incident reports 116 greater than a ticket volume threshold, and/or a cost of service greater than a service cost threshold. The ticket volume threshold is a previously defined maximum number of service requests 114 and incident reports 116 during a given time period, and the service cost threshold is a previously defined maximum cost associated with a resolution to a service (i.e. request resolutions 118). In an example, self-service offering creation program 200 collects and analyzes information (in step 202) and determines that ticket database 112 includes a high volume of service requests 114 and incident reports 116 associated with an authentication failure during a time period (i.e. a day, a week, etc). In this example, self-service offering creation program 200 utilizes financial information 117 to determine that high cost of service is associated with the authentication failure. Since the authentication failures have a high frequency (a high volume during a period of time) of associated tickets in ticket database 112, and a high cost associated with service, self-service offering creation program 200 determines the authentication failure to be a self-service offering candidate. In exemplary embodiments, responsive to analysis (i.e. high frequency of tickets, high service cost) by ticket analyzer 132, self-service offering creation program 200 can determine one or more self-service offering candidates for inclusion in service catalog 150.

In step 206, self-service offering creation program 200 determines a fulfillment solution corresponding to the self-service offering candidate. In one embodiment, self-service offering creation program 200 utilizes offering generator 134 to determine a fulfillment solution for a self-service offering candidate received from ticket analyzer 132. In this embodiment, offering generator 134 utilizes service offering templates 135 and request resolutions 118 to determine an appropriate fulfillment solution for the received self-service offering candidate. Self-service offering creation program 200 utilizes information in request resolutions 118 that indicates methods personnel associated with service desk 110 utilize to resolve service requests 114 and incident reports 116. Service offering templates 135 includes template workflows for methods to resolve self-service offerings (i.e. obtaining manager approvals, invoking and running operations or scripts). In exemplary embodiments, self-service offering creation program 200 determines a fulfillment solution for the self-service offering candidate from a workflow template in service offering templates 135 and previous solutions to the offering utilized by service desk 110. In an example, self-service offering creation program 200 matches the self-service offering candidate with a corresponding solution in request resolutions 118. In this example, self-service offering creation program 200 matches the self-service offering candidate to a workflow in service offering templates 135, wherein the workflow includes obtaining appropriate approval (i.e. for cleaning the cache of client software having authentication problems), and then and invoking operations (i.e. restarting the authentication module) to resolve the issue associated with the self-service offering candidate. In exemplary embodiments, the fulfillment solution corresponding to the self-service offering includes a corresponding workflow, cost of service in service desk 110, and additional information corresponding to the issue that the self-service offering addresses (i.e. program associated with an authentication failure, an error code, associated user identification, etc).

In decision step 208, self-service offering creation program 200 determines whether the fulfillment solution corresponding to the self-service offering candidate requires modifications. In one embodiment, self-service offering creation program 200 receives an indication from an individual associated with service catalog manager 130 and service catalog 150 (i.e. a manager of service catalog manager 130 and/or service catalog 150) of whether any modifications should be made to the fulfillment solution corresponding to the self-service offering candidate before being added to storage device 152 on service catalog 150. In exemplary embodiments, self-service offering creation program 200 utilizes offering activator 136 to determine whether fulfillment solutions corresponding to self-service offering candidates require modifications. For example, an individual associated with service catalog manager 130 (i.e. a manager of service catalog manager 130 and/or service catalog 150) accesses offering activator 136 and provides an indication of whether the fulfillment solution corresponding to the self-service offering candidate requires modifications.

In step 210, self-service offering creation program 200 receives modifications to the fulfillment solution corresponding to the self-service offering candidate. In one embodiment, an individual associated with service catalog manager 130 and service catalog 150 (i.e. a manager of service catalog manager 130 and/or service catalog 150) indicates that the fulfillment solution corresponding to the self-service offering requires modifications, and provides the necessary modifications. In exemplary embodiments, self-service offering creation program 200 utilizes offering activator 136 to receive and implement the modifications into the fulfillment solution corresponding to the self-service offering candidate. Modifications to the fulfillment solution corresponding to the self-service offering candidate can include modifications to a workflow associated with the self-service offering candidate (determined in step 206), or an indication that self-service offering creation program 200 should not add the self-service offering candidate to storage device 152 on service catalog 150.

In step 212, self-service offering creation program 200 receives approval for the fulfillment solution corresponding to the self-service offering. In one embodiment, self-service offering creation program 200 receives approval from an individual associated with service catalog manager 130 and service catalog 150 (i.e. a manager of service catalog manager 130 and/or service catalog 150), and that no further modifications are necessary (i.e. modification made in step 210 or indication of no required modifications in decision step 208). In exemplary embodiments, self-service offering creation program 200 utilizes offering activator 136 to receive approval indications for fulfillment solutions corresponding to self-service offering candidates.

In step 214, self-service offering creation program 200 adds the approved self-service offering candidate and corresponding fulfillment solution to the service catalog. In one embodiment, self-service offering creation program 200 utilizes offering activator 136 to add and activate the self-service offering candidate in service catalog 150. In this embodiment, now an individual utilizing client device 120 can access the self-service offering in service catalog 150 and have the issue resolved automatically instead of contacting service desk 110 to resolve an associated issue.

FIG. 3 is a flowchart depicting operational steps of self-service offering disposal program 300 in accordance with an exemplary embodiment of the present invention. In one embodiment, self-service offering disposal program 300 utilizes offering disposer 138 in service catalog manager 130.

In step 302, self-service offering disposal program 300 analyzes usage information and financial information corresponding to self-service offerings in the service catalog. In one embodiment, self-service offering disposal program 300 utilizes offering disposer 138 to access usage information and financial information included in storage device 152 associated with self-service offerings included in service catalog 150. The usage information includes, but is not limited to the utilization of self-service offerings during a given time period (i.e. per day, per week). The financial information includes, but is not limited to costs and cost savings associated with the self-service offering. In exemplary embodiments, self-service offering disposal program 300 analyzes the usage and financial information looking for self-service offerings in service catalog 150 having low usage rates, and not generating sufficient revenue or cost savings. Self-service offering disposal program 300 utilizes offering disposer 138, which continuously analyzes storage device 152 in service catalog 150.

In step 304, self-service offering disposal program 300 determines a self-service offering that is not meeting usage or revenue requirements. In one embodiment, self-service offering disposal program 300 utilizes offering disposer 138 to determine a self-service offering in service catalog 150. In exemplary embodiments, self-service offering disposal program 300 determines self-service offerings in service catalog 150 that do not meet previously defined usage or revenue thresholds. In an example, an individual associated with service catalog manager 130 and service catalog 150 (i.e. a manager of service catalog manager 130 and/or service catalog 150) defines usage and revenue thresholds for self-service offerings in service catalog 150, wherein the usage threshold indicates a minimum amount of uses per day, and the revenue threshold indicates a minimum amount of cost savings associated with a self-service offering. In this example, self-service offering disposal program 300 determines that a self-service offering is not meeting the usage and revenue thresholds and the determined self-service offering can be removed from storage device 152 in service catalog 150. In another example, self-service offering disposal program 300 can determine that a self-service offering is not meeting the usage threshold, or the revenue threshold. In this example, self-service offering disposal program 300 can determine that the self-service offering can be removed from storage device 152 in service catalog 150.

In step 306, self-service offering disposal program 300 receives approval to remove the determined self-service offering from the service catalog. In one embodiment, self-service offering disposal program 300 receives approval from an individual associated with service catalog manager 130 and service catalog 150 (i.e. a manager of service catalog manager 130 and/or service catalog 150) that self-service offering disposal program 300 can remove a determined self-service offering from storage device 152 in service catalog 150. In exemplary embodiments, self-service offering disposal program 300 utilizes offering disposer 138 to receive approval indications corresponding to removal of self-service offerings.

In step 308, self-service offering disposal program 300 removes the determined self-service offering from the service catalog. In one embodiment, self-service offering disposal program 300 utilizes offering disposer 138 to deactivate and remove self-service offerings from storage device 152 in service catalog 150. In exemplary embodiments, self-service offering disposal program 300 continuously operates to deactivate and remove self-service offerings in service catalog 150 that do not meet usage and/or revenue requirements.

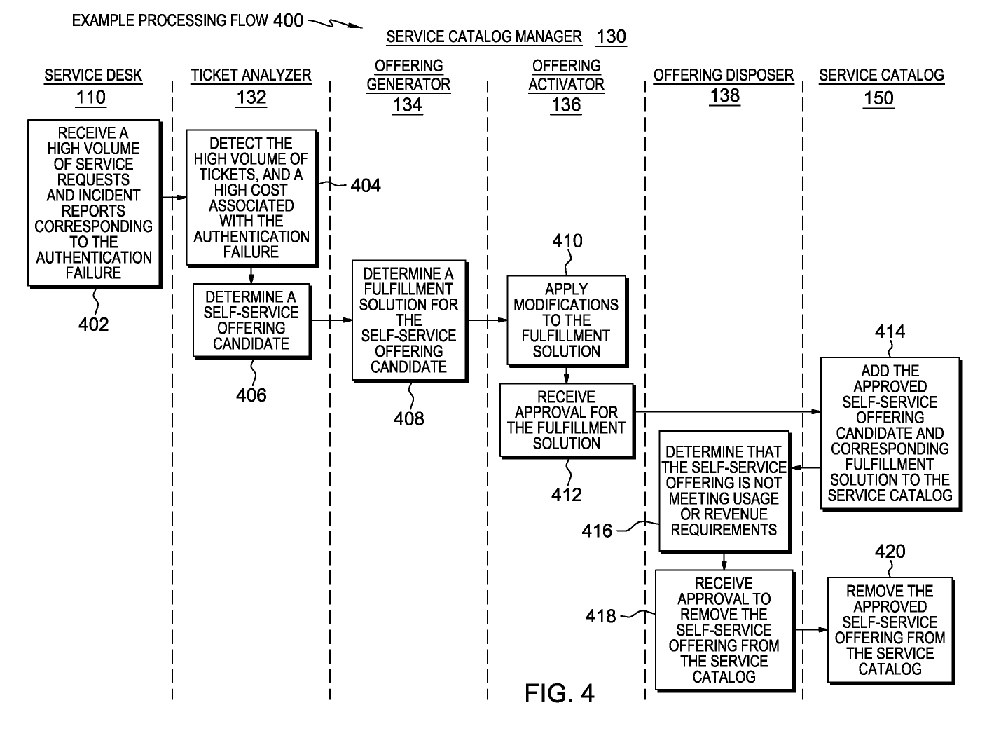

FIG. 4 is a flowchart depicting operational steps of example processing flow 400 in accordance with an exemplary embodiment of the present invention. Example processing flow 400 depicts an exemplary flow of information processed through self-service offering creation program 200 and self-service offering disposal program 300 through service desk 110, elements of service catalog manager 130 (ticket analyzer 132, offering generator 134, offering activator 136, and offering disposer 138), and service desk 150. In exemplary embodiments, unexpected situations can lead to an increased number of service requests 114 and incident reports 116 on service desk 110. In an example with regard to example processing flow 400, integration of a new component into an operating environment leads to authentication problems for devices in the operating environment (i.e. client device 120 in data processing environment 100).

In step 402, service desk 110 receives a high volume of service requests and incident reports corresponding to the authentication failure. In exemplary embodiments, service desk 110 receives service requests 114 and incident reports 116 from client device 120 and other devices. Service desk stores service requests 114 and incident reports 116 in ticket database 112.

In step 404, ticket analyzer 132 detects a high volume of tickets and a high cost associated with the authentication failure. In one embodiment while analyzing ticket database 112 on service desk 110, ticket analyzer 132 detects a high volume of service requests 114 and incident reports 116 associated with the authentication failure, as well as a high cost associated with resolution of the service requests 114 and incident reports 116 (included in financial information 117).

In step 406, ticket analyzer 132 determines a self-service offering candidate. In exemplary embodiments, ticket analyzer 132 determines a self-service offering candidate corresponding to the tickets detected in step 404. In an example, ticket analyzer 132 determines that the high volume of tickets and cost associated to the authentication failure warrants inclusion of a self-service offering in service catalog 150. Ticket analyzer 132 sends the self-service offering candidate to offering generator 134.

In step 408, offering generator 134 determines a fulfillment solution for the self-service offering candidate. In one embodiment, offering generator 134 receives a self-service offering candidate from ticket analyzer 132. In exemplary embodiments, offering generator 134 utilizes service offering templates 135 and request resolutions 118 to determine a fulfillment solution corresponding to the self-service offering candidate. In an example, the fulfillment solution includes a workflow capable of resolving the authentication failure, and information corresponding to the issue that the self-service offering addresses (i.e. cost of service in service desk 110). An exemplary process for determining a fulfillment solution corresponding to a self-service offering candidate is discussed in greater detail with regard to FIG. 2. Offering generator 134 sends the fulfillment solution for the self-service offering candidate to offering activator 136.

In step 410, offering activator 136 applies modifications to the fulfillment solution. In one embodiment, offering activator 136 receives a self-service offering candidate and corresponding fulfillment solution from offering generator 134. In an example, individual associated with service catalog manager 130 and service catalog 150 (i.e. a manager of service catalog manager 130 and/or service catalog 150) indicates that the fulfillment solution for the self-service offering candidate corresponding to the authentication failure requires modifications. In this example, the individual associated with service catalog manager 130 and service catalog 150 makes the modifications to the fulfillment solution in offering activator 136. An exemplary process of determining whether or not a fulfillment solution requires modification is discussed in greater detail with regard to FIG. 2. In another embodiment, an individual associated with service catalog manager 130 and service catalog indicates that no modifications are necessary.

In step 412, offering activator 136 receives approval for the fulfillment solution. In exemplary embodiments, offering activator 136 receives approval from an individual associated with service catalog manager 130 and service catalog 150 (i.e. a manager of service catalog manager 130 and/or service catalog 150), and that no further modifications are necessary (i.e. modifications made in step 410, or an indication of no necessary modifications).

In step 414, offering activator 136 adds the approved self-service offering candidate and corresponding fulfillment solution to the service catalog. In one embodiment, an individual utilizing client device 120 can access the self-service offering in service catalog 150 instead of contacting service desk 110 to resolve the authentication failure.

In step 416, offering disposer 138 determines that the self-service offering is not meeting usage or revenue requirements. In an example, offering disposer analyzes usage and financial information for self-service offerings on service catalog 150 over time, and after three weeks offering disposer 138 determines that the self-service offering associated with the authentication failure does not meet usage and/or revenue requirements. In this example, offering disposer 138 determines that the self-service offering can be removed from storage device 152 in service catalog 150. An exemplary process for determining a self-service offering to remove from service catalog 150 is discussed in greater detail with regard to FIG. 3.

In step 418, offering disposer 138 receives approval to remove the self-service offering from the service catalog. In one embodiment, offering disposer 138 receives approval from an individual associated with service catalog manager 130 and service catalog 150 (i.e. a manager of service catalog manager 130 and/or service catalog 150) that a determined self-service offering (i.e. the self-service offering associated with the authentication failure) can be removed from storage device 152 in service catalog 150.

In step 420, offering disposer 138 removes the approved self-service offering from the service catalog. In an exemplary embodiment, responsive to receiving approval, offering disposer 138 deactivates and removes the self-service offering corresponding to the authentication failure from storage device 152 in service catalog 150.

FIG. 5 depicts a block diagram of components computer 500 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computer 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media. Software and data 522 stored in persistent storage 508 for access and/or execution by processor(s) 504 via one or more memories of memory 506. With respect to client device 120, software and data 522 includes system software 110. With respect to service catalog manager 130, software and data 522 includes self-service offering creation program 200 and self-service offering disposal program 300.

In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Software and data 522 may be downloaded to persistent storage 508 through communications unit 510.

I/O interface(s) 512 allows for input and output of data with other devices that may be connected to computer 500. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data 522 can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor. Display 520 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for service catalog management, the method comprising:
a computer identifying information corresponding to a plurality of service requests included on a service desk, wherein the identified information includes usage information and financial information corresponding to the plurality of service requests;
the computer determining a service offering candidate for inclusion in a service catalog, wherein the service offering candidate is determined from the plurality of service requests included in the service desk; and
the computer determining a fulfillment solution corresponding to the service offering candidate, wherein the fulfillment solution includes a workflow process for the service offering candidate, scripts for automating procedures, offering parameters, and costs associated with the service offering candidate.

2. The method of claim 1, further comprising:
the computer receiving an indication that the determined fulfillment solution corresponding to the service offering candidate is approved; and
the computer adding and activating the approved service offering candidate and corresponding fulfillment solution to the service catalog.

3. The method of claim 1, wherein said identifying a service offering candidate for inclusion in a service catalog, further comprises:
the computer analyzing usage information comprising the number of service tickets in the service desk and corresponding resolutions to service tickets, and creation times for service tickets in the service desk;
the computer analyzing financial information comprising costs associated with service tickets and corresponding resolutions in the service desk; and
the computer determining the service offering candidate for inclusion in the service catalog utilizing analyzed usage information and analyzed financial information,
wherein the determined service offering candidate corresponds to a volume of service tickets greater than a ticket volume threshold, or a cost of service greater than a service cost threshold,
wherein the ticket volume threshold is a previously defined maximum number of times a service is requested during a given time period, and the service cost threshold is a previously defined maximum cost associated with a service ticket resolution.

4. The method of claim 1, wherein said determining a fulfillment solution corresponding to the service offering candidate, further comprises:
the computer identifying a workflow process utilizing templates of resolutions to service tickets associated with service offerings, and previously utilized resolutions to service tickets; and
the computer determining a self-service fulfillment solution corresponding to the service offering candidate.

5. The method of claim 2, wherein said receiving an indication that the determined fulfillment solution corresponding to the service offering candidate is approved, further comprises:
the computer receiving modifications to the determined fulfillment solution corresponding to the service offering candidate;
the computer applying received modifications to the determined fulfillment solution corresponding to the service offering candidate; and
the computer receiving an indication that the modified determined fulfillment solution corresponding to the service offering candidate is approved.

6. The method of claim 2, further comprising:
the computer identifying information corresponding to service offerings in the service catalog, wherein the identified information includes usage information and financial information corresponding to service offerings in the service catalog;
the computer determining a service offering is capable of being removed from the service catalog;
the computer receiving an indication to remove the determined service offering from the service catalog; and
the computer deactivating and removing the determined service offering from the service catalog.

7. The method of claim 6, wherein said determining a service offering that is capable of being removed from the service catalog, further comprising:
the computer analyzing usage information, wherein the usage information comprises a number of times service offerings are utilized in a given time period;
the computer analyzing financial information, wherein the financial information comprises costs and cost savings associated with service offerings; and
the computer determining a service offering that is not meeting usage or financial thresholds, wherein the usage threshold is a previously defined minimum number of times a service offering is utilized during a given time period, and the financial threshold is a previously defined minimum cost savings or maximum cost associated with a service offering.

8. A computer program product for service catalog management, the computer program product comprising:
one or more computer-readable storage media and program instructions stored on the one or more computer-readable storage media, the program instructions comprising:
program instructions to identify information corresponding to a plurality of service requests included on a service desk, wherein the identified information includes usage information and financial information corresponding to the plurality of service requests;
program instructions to determine a service offering candidate for inclusion in a service catalog, wherein the service offering candidate is determined from the plurality of service requests included in the service desk; and
program instructions to determine a fulfillment solution corresponding to the service offering candidate, wherein the fulfillment solution includes a workflow process for the service offering candidate, scripts for automating procedures, offering parameters, and costs associated with the service offering candidate.

9. The computer program product of claim 8, further comprising program instructions to:
receive an indication that the determined fulfillment solution corresponding to the service offering candidate is approved; and
add and activate the approved service offering candidate and corresponding fulfillment solution to the service catalog.

10. The computer program product of claim 8, wherein said program instructions to identify a service offering candidate for inclusion in a service catalog, further comprises program instructions to:
analyze usage information comprising the number of service tickets in the service desk and corresponding resolutions to service tickets, and creation times for service tickets in the service desk;
analyze financial information comprising costs associated with service tickets and corresponding resolutions in the service desk; and
determine the service offering candidate for inclusion in the service catalog utilizing analyzed usage information and analyzed financial information,
wherein the determined service offering candidate corresponds to a volume of service tickets greater than a ticket volume threshold, or a cost of service greater than a service cost threshold,
wherein the ticket volume threshold is a previously defined maximum number of times a service is requested during a given time period, and the service cost threshold is a previously defined maximum cost associated with a service ticket resolution.

11. The computer program product of claim 8, wherein said program instructions to determine a fulfillment solution corresponding to the service offering candidate, further comprises program instructions to:
identify a workflow process utilizing templates of resolutions to service tickets associated with service offerings, and previously utilized resolutions to service tickets; and
determine a self-service fulfillment solution corresponding to the service offering candidate.

12. The computer program product of claim 9, wherein said program instructions to receive an indication that the determined fulfillment solution corresponding to the service offering candidate is approved, further comprises program instructions to:
receive modifications to the determined fulfillment solution corresponding to the service offering candidate;
apply received modifications to the determined fulfillment solution corresponding to the service offering candidate; and
receive an indication that the modified determined fulfillment solution corresponding to the service offering candidate is approved.

13. The computer program product of claim 9, further comprising program instructions to:
identify information corresponding to service offerings in the service catalog, wherein the identified information includes usage information and financial information corresponding to service offerings in the service catalog;
determine a service offering is capable of being removed from the service catalog;
receive an indication to remove the determined service offering from the service catalog; and
deactivate and remove the determined service offering from the service catalog.

14. The computer program product of claim 13, wherein said program instructions to determine a service offering that is capable of being removed from the service catalog, further comprising program instructions to:
analyze usage information, wherein the usage information comprises a number of times service offerings are utilized in a given time period;
analyze financial information, wherein the financial information comprises costs and cost savings associated with service offerings; and
determine a service offering that is not meeting usage or financial thresholds, wherein the usage threshold is a previously defined minimum number of times a service offering is utilized during a given time period, and the financial threshold is a previously defined minimum cost savings or maximum cost associated with a service offering.

15. A computer system for service catalog management, the computer system comprising:
one or more computer processors; and
one or more computer-readable storage media;
program instructions stored on the computer-readable storage media for execution by at least one of the one or more processors, the program instructions comprising:
program instructions to identify information corresponding to a plurality of service requests included on a service desk, wherein the identified information includes usage information and financial information corresponding to the plurality of service requests;
program instructions to determine a service offering candidate for inclusion in a service catalog, wherein the service offering candidate is determined from the plurality of service requests included in the service desk; and
program instructions to determine a fulfillment solution corresponding to the service offering candidate, wherein the fulfillment solution includes a workflow process for the service offering candidate, scripts for automating procedures, offering parameters, and costs associated with the service offering candidate.

16. The computer system of claim 15, further comprising program instructions to:
receive an indication that the determined fulfillment solution corresponding to the service offering candidate is approved; and
add and activate the approved service offering candidate and corresponding fulfillment solution to the service catalog.

17. The computer system of claim 15, wherein said program instructions to identify a service offering candidate for inclusion in a service catalog, further comprises program instructions to:
analyze usage information comprising the number of service tickets in the service desk and corresponding resolutions to service tickets, and creation times for service tickets in the service desk;
analyze financial information comprising costs associated with service tickets and corresponding resolutions in the service desk; and
determine the service offering candidate for inclusion in the service catalog utilizing analyzed usage information and analyzed financial information,
wherein the determined service offering candidate corresponds to a volume of service tickets greater than a ticket volume threshold, or a cost of service greater than a service cost threshold,
wherein the ticket volume threshold is a previously defined maximum number of times a service is requested during a given time period, and the service cost threshold is a previously defined maximum cost associated with a service ticket resolution.

18. The computer system of claim 15, wherein said program instructions to determine a fulfillment solution corresponding to the service offering candidate, further comprises program instructions to:
identify a workflow process utilizing templates of resolutions to service tickets associated with service offerings, and previously utilized resolutions to service tickets; and
determine a self-service fulfillment solution corresponding to the service offering candidate.

19. The computer system of claim 16, wherein said program instructions to receive an indication that the determined fulfillment solution corresponding to the service offering candidate is approved, further comprises program instructions to:
receive modifications to the determined fulfillment solution corresponding to the service offering candidate;
apply received modifications to the determined fulfillment solution corresponding to the service offering candidate; and
receive an indication that the modified determined fulfillment solution corresponding to the service offering candidate is approved.

20. The computer system of claim 16, further comprising program instructions to:
identify information corresponding to service offerings in the service catalog, wherein the identified information includes usage information and financial information corresponding to service offerings in the service catalog;
determine a service offering is capable of being removed from the service catalog;
receive an indication to remove the determined service offering from the service catalog; and
deactivate and remove the determined service offering from the service catalog.
